(19) United States
(12) Patent Application Publication
(10) Pub. No.: US 2025/0274198 A1
(43) Pub. Date: Aug. 28, 2025

(54) Beam Dump and Power Meter such as for Free-Space Optical Communication Systems

(71) Applicant: Aalyria Technologies, Inc., Livermore, CA (US)

(72) Inventors: Richard Allison YOUNG, Eagle, ID (US); Igor LANDAU, Boulder, CO (US)

(21) Appl. No.: 18/587,547

(22) Filed: Feb. 26, 2024

(51) Int. Cl. H04B 10/50; G02B 27/14

(52) U.S. Cl. CPC H04B 10/503; G02B 27/144

(57) ABSTRACT

The present disclosure is directed to a beam dump for trapping and absorbing a first portion of a laser beam, and for reflecting a second portion of the laser beam to a power meter to estimate power of the laser beam in a free-space optical communication (FSOC) terminal. The beam dump can encounter the laser beam as an artifact that was passed through, reflected, or deflected by another component of the FSOC terminal, such as at an antireflection coating. The beam dump can trap and absorb a first portion of the laser beam (e.g., through total internal reflection and its doped semiconductor qualities), while the antireflection coating can reflect the second portion of the laser beam (e.g., 1%) to the power meter. In some implementations, multiple beam dump-power meters assemblies can be included in the FSOC terminal for comparison of measurements and to ensure operability of the FSOC terminal.

### TECHNICAL FIELD

The present disclosure is directed to a beam dump for trapping and absorbing a first portion of a collimated light beam (e.g. a laser), and for reflecting a second portion of the collimated light beam to a power meter to estimate power of the collimated light beam in a free-space optical communication terminal.

### BACKGROUND

Free-space optical communication (FSOC), due to its high data rate, high capacity, free license spectrum, and excellent security, offers an alternative to Radio Frequency (RF) or microwave communication in modern wireless communication. In a free-space optical communication system, a transmitter may transmit data at a high speed (e.g., greater than 1 Gbps, 10 Gbps, 100 Gbps, 1 Tbps, or higher) using a narrow laser beam (e.g., in infrared wavelengths) that passes through the atmosphere to a line of-sight receiver. Free-space optical communication can offer point-to-point data communication at rates faster than other solutions available today, cover greater distances, offer connectivity where no supporting infrastructure exists, and is not susceptible to RF-based jamming techniques intended to interfere and disrupt the operation of RF communication systems. For example, free-space optical communication systems may be used to provide links to, from, or between aircrafts, spacecrafts, balloons, satellites, ground vehicles and stations, and water-based vehicles and stations, and can deliver data services at high speed to sites that may otherwise have no access to high speed networks such as fiber optical networks. Free-space optical communication can radically improve satellite communications, connectivity on planes and ships, cellular connectivity, etc.

### BRIEF DESCRIPTION OF THE DRAWINGS

FIG. 1 is an example of a communication network that may be implemented using free-space optical communication.

FIG. 2 is an example of a point-to-point free-space optical communication system.

FIG. 3A is an example of a bistatic free-space optical communication system.

FIG. 3B is an example of a monostatic free-space optical communication system.

FIG. 4 includes simplified block diagrams of examples of terminals in a free-space optical communication system according to some implementations.

FIG. 5 illustrates a block diagram of an example of a free-space optical communication terminal according to some implementations.

FIG. 6 illustrates an example of an optical front end in an optical head of a free-space optical communication terminal according to some implementations.

FIG. 7 illustrates an example of an optical back end in an optical head of a free-space optical communication terminal according to some implementations.

FIG. 8A illustrates an example exploded view of a beam dump assembly for an optical front end or an optical back end in an optical head of a free-space optical communication terminal according to some implementations.

FIG. 8B illustrates an example top view of a prism positioned within a mount of a beam dump assembly for an optical head of a free-space optical communication terminal according to some implementations.

FIG. 8C illustrates an example cross-sectional view at A-A of a photo diode with connectors positioned within a mount of a beam dump assembly for an optical head of a free-space optical communication terminal according to some implementations.

FIGS. 9A and 9B illustrate example views of a prism for a beam dump assembly according to some implementations.

FIG. 9C illustrates an example view of a laser beam traveling through a system including a prism for a beam dump assembly and a power meter for measuring power of a portion of the laser beam.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to free-space optical communication (FSOC) using a beam dump assembly with a power meter. FSOC systems use high-powered laser beams for long distance point-to-point communication, particularly through changing environmental and atmospheric conditions. However, FSOC systems can include electronic components (e.g., sensors) that can be easily damaged by unintentionally scattered, reflected, or deflected high powered light. Thus, aspects of the present disclosure provide for beam dumps, e.g., configured for use in FSOC terminals, that can absorb excess energy, and prevent unwanted laser light from entering sensitive components that can overheat or become damaged. Further, some implementations provide power meters that can measure power of the laser beam, e.g., as it traverses an FSOC terminal (and, in some implementations, between transmitting and receiving FSOC terminals), and compare such measurements to expected values, e.g., those collected at other points in the FSOC system to ensure system operability. While “laser” systems are referred to throughout this disclosure, it will be understood that many of the systems and methods disclosed herein can use other types of collimated light and such other collimated light can be substituted for laser throughout this disclosure.

In some implementations, the beam dump can be a doped semiconductor prism (e.g., a boron-doped silicon prism) configured to absorb the power of a portion of a laser beam deflected, scattered, reflected, or passed by an optical component into the beam dump. In some implementations, the prism can be a trapezoidal prism, such as a right trapezoidal prism (i.e., having two trapezoids joined by four rectangles), composed of the doped semiconductor material. The prism can be configured to trap the received portion of the laser beam within its volume by total internal reflection. The semiconductor material can be doped to an appropriate degree to absorb the received portion of the laser beam at the target wavelength of the laser beam, e.g., 1555 nm.

In some implementations, the prism can include at least a partial antireflection coating on one of its faces, such as on one of its rectangular faces. The prism can be positioned such that a portion of the laser beam is received through the antireflection coating. In some implementations, the antireflection coating can allow all or substantially all of the received laser beam to enter the prism. In some implementations, the antireflection coating can reflect a portion of the received laser beam (e.g., 1%) to a power meter.

In one example, such a beam dump-power meter system (also referred to herein as a “beam dump assembly”) can be provided both at the source and output of a FSOC terminal (i.e., when the FSOC terminal is acting as a transmitter), and a controller can compare the readings to ensure proper operation of its transmitting functions. In another example, a beam dump-power meter system can be provided both at the input and the receiver of the FSOC terminal (i.e., when the FSOC terminal is acting as a receiver), and a controller can compare the readings to ensure proper operation of its receiving functions. In some implementations, a controller can compare the power reading at the output of the transmitting terminal to the power reading at the input of the receiving terminal to assess power throughput.

In some implementations, expected powers for a laser beam to be transmitted at various points in the FSOC terminal and/or expected powers for received laser beams at various points in the FSOC terminal can be stored in a lookup table or defined in a transform function, and/or expected ratios of any combinations of these powers can be stored in a lookup table. If the power readings are not as expected (and/or if no power reading is available at a particular point), the controller can disable the FSOC terminal, disable a portion of the FSOC terminal, disable one or more of its functionalities, or reduce light power, as damage to one or more of its components or fibers is likely. In some implementations, the FSOC terminals can be transceivers (i.e., perform both transmitting and receiving functions), and can include beam dumps and/or power meters to absorb excess energy and/or measure the power of both transmitted and received laser beams.

Aspects of the present disclosure further provide for an optical system. The optical system can include an optical antenna configured to A) receive, B) transmit, or C) both, laser beams through a first aperture. The optical system can further include a deformable mirror configured to i) scan, within a field of regard, a beacon beam to be transmitted for laser beam tracking, ii) scan, within a field of regard, to acquire a beacon beam transmitted by a first terminal, or iii) both. The optical system can further include a power selector configured to split the beacon beam into a first light beam and a second light beam, and a wavefront sensor configured to measure a wavefront of the first light beam. The optical system can further include a beam dump comprising a doped semiconductor prism. In some implementations, the beam dump can be configured to trap, by total internal reflection, at least a portion of the beacon beam, such that at least the portion is not reflected onto the wavefront sensor. The beam dump can further be configured to absorb, via the doped semiconductor prism, at least the portion of the beacon beam. The optical system can further include a collimator configured to couple the second light beam into an optical fiber, and a controller configured to control the deformable mirror for laser beam tracking. In some implementations, the optical system can further include a power meter configured to detect power of a second portion of the beacon beam reflected by the beam dump.

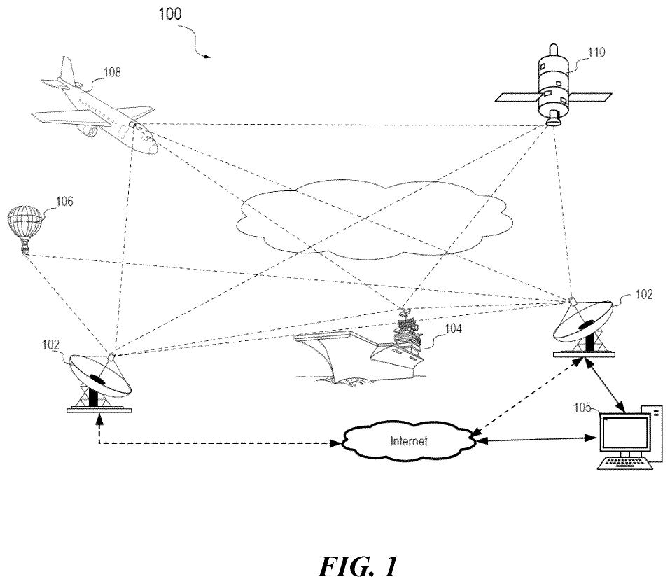

FIG. 1 illustrates an example of a communication network 100 that may be implemented using free-space optical communications. Communication network 100 may be a directional point-to-point communication network including network nodes (e.g., communication terminals) on various land-based, sea-based, air-based, or space-based structures, some of which may be mobile and can change position with respect to other nodes in communication network 100 over time. In the illustrated example, communication network 100 may include one or more datacenters 105, one or more land-based nodes 102, one or more sea-based nodes 104 (e.g., ships), and one or more airborne high altitude platforms (HAPs), such as one or more balloons 106, one or more airplanes 108, and one or more satellites 110. It is noted that communication network 100 shown in FIG. 1 is for illustration purposes only. In some implementations, communication network 100 may include additional or different network nodes. For example, in some implementations, communication network 100 may include additional HAPS, such as blimps, unmanned aerial vehicles (UAVs), or any other form of high altitude platforms. In some implementations, communication network 100 may serve as an access network for client devices such as cellular phones, laptop computers, desktop computers, wearable devices, or tablet computers. Communication network 100 may be connected to a larger computer network, such as the Internet, and may be configured to provide a client device with access to resources stored on or provided through the larger computer network.

Some network nodes in communication network 100 may communicate with each other using wireless communication links through the atmosphere. In some implementations, at least some nodes in communication network 100 may include wireless transceivers associated with a cellular or other mobile network, such as eNodeB base stations or other wireless access points, such as WiMAX or UMTS access points. Some land-based nodes 102, sea-based nodes 104, balloons 106, airplanes 108, and satellites 110 may communicate with datacenter 105 directly (e.g., through RF communication with an antenna of datacenter 105), through the Internet, through a network nodes (e.g., a land-based node 102), or through backbone network links or transit networks operated by third parties. Land-based nodes 102, sea-based nodes 104, balloons 106, airplanes 108, and satellites 110 may provide wireless access for the users, and can route user requests to the datacenters 105 and return responses to the users via the backbone network links.

Datacenters 105 may include servers hosting applications that can be accessed by remote users and systems that monitor and control the nodes of communication network 100. In some implementations, datacenter 105 may implement a software platform for orchestrating land-based nodes 102, sea-based nodes 104, balloons 106, airplanes 108, and satellites 110, and other land-based networks. For example, the software platform may optimize and continually evolve the network link scheduling, traffic routing, and spectrum resources in real time. In one example, the software platform may provide information (e.g., location information) to two nodes that need to establish a point-to-point direct optical link between the two nodes, so that the two nodes can find each other in the three-dimensional space and establish the direct optical link. In some embodiments, datacenter 105 may operate networks across land, sea, air, and space, at any altitude or orbit type, support many radio frequency bands and optical wavelengths, and may be designed for interoperability with legacy, hybrid space, 5G new radio, non-terrestrial network (NTN), and future generation network architectures.

Some nodes of communication network 100 may be configured to communicate with one another using steerable wireless transceivers. For example, land-based nodes 102, sea-based nodes 104, balloons 106, airplanes 108, and satellites 110 may include optical transceivers and thus may directly communicate with each other using point-to-point optical links through the atmosphere. The optical transceivers may be mounted to actuators (e.g., gimbals) that may be controlled to point in a desired direction. To form a link between two nodes, the transceivers of the respective nodes can be controlled (e.g., based on information received from datacenter 105) to point in the direction of one another so that data can be transmitted and received between the two nodes. In some implementations, some of the nodes may include transceivers with omnidirectional antennas and therefore are not required to be steered towards other nodes to form communication links. Some of the nodes may include directional transceivers whose positions and pointing directions may be fixed. In some implementations, parameters associated with each transceiver may be controlled to facilitate formation of the links in communication network 100. For example, nodes having steerable directional antennas can be controlled to point in the direction of nodes with which they are to establish links. In addition, the power of the signals transmitted by each transceiver can also be controlled to facilitate formation of the links in communication network 100. For example, transceivers of nodes that are separated by a relatively large distance can be configured to operate at a higher power to compensate for the loss of signal-to-noise ratio that occurs over the distance separating the two nodes. Transceivers of nodes that are spaced nearer to one another may be controlled to operate at a relatively low power so as to save power. The communication channels and protocols for pairs of nodes that are to establish links can also be controlled to facilitate the formation of the links in communication network 100.

In general, each directional transceiver can be aimed at only one other transceiver at a given time, and each transceiver may be able to operate at a sufficiently high power level in order to form a link with a transceiver of another node. Omnidirectional nodes may only be capable of forming a limited number of simultaneous communication links and may transmit or receiver data at a low bandwidth in each communication link. As a result, the feasible topologies and available bandwidth for communication network 100 at a given time may be constrained. For example, each network node may have a fixed number of transceivers, and thus the number of links coupling a first node to other nodes (sometimes referred to as the degree of the first node) may not be greater than the number of transceivers associated with the first node. Furthermore, the maximum range for each transceiver may be limited by the maximum power output for the transceiver, and therefore a link may not be established between a pair of nodes that are separated by a distance that exceeds the maximum range for either one of the transceivers. In some implementations, the maximum power output for a transceiver can be constrained based on a variety of factors, such as a battery level, weather conditions that may impact solar power generation rates, remaining flight time for a HAP, and the like.

Further constraint on the feasible topologies of communication network 100 may include the requirement that the path between a pair of nodes should be clear of obstructions in order for the nodes to form a line-of-sight link. In some implementations, the relative motion of the nodes in communication network 100 may prevent the formation of links at some points in time. For example, a link between a balloon 106 (or an airplane 108) and a land-based node 102 (land station) may become unreliable, unfeasible, or unavailable at times during which clouds, mountains, buildings, or other obstacles are positioned between the two nodes. Thus, movement of some nodes, as well as external events such as weather or failure of one or more transceivers, may limit the nodes that are reachable from a given node at a given time in communication network 100. As result, links and routing information may need to be continuously updated based on the respective locations of the network nodes and other properties of the network nodes to maintain connectivity across communication network 100 over time. In some implementations, an input graph representing all of the possible links that can be formed in the network at a given time can be generated and processed to generate a subgraph that conforms to the constraints discussed above while satisfying any provisioned network flows.

As described above, free-space optics communication (FSOC) may offer an alternative to radio frequency (RF) and microwave communication in modern wireless communication due to its high data rate, high capacity, cost-effectiveness, free license spectrum, excellent security, rapid deployment, and the like. For example, in a free-space optical communication system, a transmitter may transmit data at a data rate greater than about 1 Gbps, greater than about 10 Gbps, greater than about 100 Gbps, greater than about 1 Tbps, or higher. However, optical signals transmitted through the atmosphere may be affected by the atmosphere before arriving at a line-of-sight receiver. Atmospheric effects, such as atmospheric turbulence, may deteriorate free-space laser beam transmission by reducing the overall optical power level received by a detector of the receiver due to atmospheric attenuation, and/or causing random optical power fluctuations in the received signal resultant from beam deformation, scintillation effects, beam wander, and the like. To overcome such effects of the atmosphere on the transmitted laser beam, adaptive optics may be used to correct the phase perturbations (aberrations) in the received light beam, such that the received light beam may be focused into a single symmetric (e.g., circular) light spot that can be more efficiently coupled into the fiber. An adaptive optics system may generally estimate the phase perturbations (aberrations) of the received light beam and generate additional phase changes conjugated with the estimated phase perturbations in the received light beam (e.g., using a deformable mirror or an SLM) to compensate for the disturbances. In many AO systems, the performance of phase-only AO compensation may be limited due to, for example, limited accuracy and/or resolution of the phase aberration estimation or measurement, and/or limited phase compensation range, resolution, accuracy, and speed of the phase compensation components (e.g., deformable mirrors or SLMs).

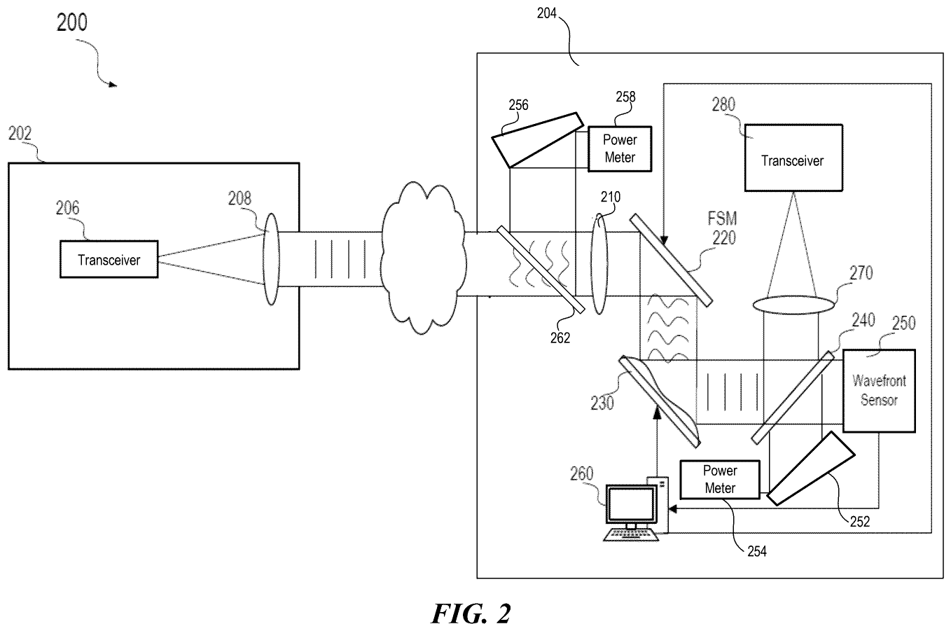

FIG. 2 illustrates an example of a point-to-point free-space optical communication system 200. In the example illustrated in FIG. 2, FSOC system 200 includes two terminals 202 and 204 in a point-to-point optical link through atmosphere. Terminals 202 and 204 may be mounted to any of the network nodes of communication network 100 described above with respect to FIG. 1. Terminal 202 may include a transceiver 206. When functioning as a transmitter, transceiver 206 can be configured to generate optical signals that are modulated using data to be transmitted. Terminal 202 may also include an optical antenna 208 configured to substantially collimate the optical signals to form a laser beam with a small divergence angle and transmit the laser beam towards terminal 204. The transmitted laser beam at the output aperture of terminal 202 may be a plane wave having a flat wavefront. Although illustrated and described herein as including only optical antenna 208 at terminal 202 when functioning as a transmitter, it is contemplated that transceiver 206 can also function as a terminal receiver. In such implementations, terminal 202 can have similar components and functions as those described herein with respect to terminal 204.

In the example shown in FIG. 2, terminal 204 may include a fast steering mirror (FSM) 220, which may be controlled to steer the light beam received by optical antenna 210 to correct the angle of incidence when acting as a receiver. FSM 220 may steer the received light beam towards a deformable mirror 230 or another phase correction device, such as a liquid crystal device or a spatial light modulator. Deformable mirror 230 may be controlled to change the shape of its reflective surface, thereby applying appropriate phase delays to different regions of the received light beam to change the wavefront of the received light beam. The light beam reflected by deformable mirror 230 may be split by a beam splitter 240, where a portion of the light beam may be directed towards a wavefront sensor 250, whereas the other portion of the light beam may be directed to transceiver 280 by optics 270. Wavefront sensor 250 may measure the wavefront of the received light beam. The measured wavefront may be used by a controller 260 to control deformable mirror 230 and/or FSM 220. The control loop may allow real-time control of FSM 220 and the deformable mirror surface, such that the phase delays applied by the deformable mirror to the received light beam may compensate the phase aberrations of the received light beam to achieve a substantially flat wavefront. As such, optics 270 may form a single light spot on the image plane (e.g., an input port of a single-mode fiber of transceiver 280).

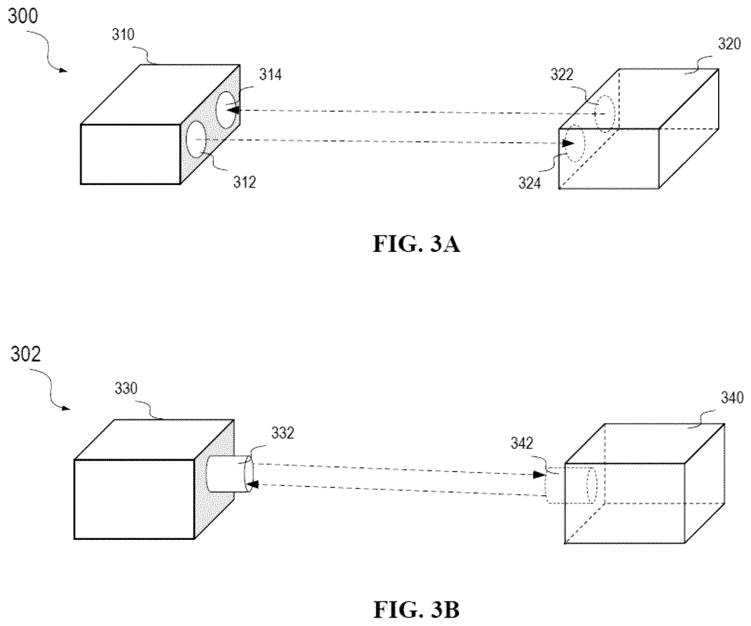

In some implementations, transceiver 206 and transceiver 208 can concurrently act as transmitters and receivers. Thus, in some implementations, transceiver 206 and transceiver 208 can utilize one or more of the same components in the sending and receiving paths. However, in some implementations, transceiver 206 and transceiver 208 can utilize different optics and/or components in their transmit and receive paths, such as is described further with respect to FIG. 3A. When acting as a transmitter, transceiver 280 can be configured to generate optical signals that are modulated using data to be transmitted. Optics 270 can be configured to substantially collimate the optical signals to form a light beam with a small divergence angle. The laser beam can be split by beam splitter 240. A fraction of the light beam may be directed (or scattered) to beam dump 252, whereas the other portion of the light beam may be directed to deformable mirror 230. A fraction (e.g., 1%, 2%, 5%, or 10%) of the laser beam received at beam dump 252 may be sent (e.g., reflected or deflected) by beam dump 252 to power meter 254 to estimate the power of the laser beam to be transmitted. Beam dump 252 can trap and absorb the remaining power of its received portion of the laser beam, as described further herein, thus preventing high power light from scattering back into terminal 204, which could damage, e.g., wavefront sensor 250, and/or otherwise disrupt operation of terminal 204. The portion of the light beam directed to deformable mirror 230 can be transmitted by optical antenna 210 towards terminal 202. The transmitted laser beam at the output aperture of terminal 204 may be a plane wave having a flat wavefront.

In some implementations, terminal 204 can include an additional beam dump 256 and/or power meter 258 at its output. For example, beam dump 256 can be positioned to absorb any light reflected by mirror 262 from FSM 220. In some implementations, beam dump 256 can further reflect a small portion of the light to power meter 258. In other words, beam dump 256 can receive a deflected portion of the light beam to be transmitted by optical antenna 210 from terminal 202. As with beam dump 252, beam dump 256 can dissipate excess energy without having back reflection into terminal 204. In some implementations, a computing system (not shown) can analyze power readings from power meter 254 and power meter 258 at the output to ensure that the ratio between those levels is within acceptable variation levels, thereby ascertaining that terminal 204 is healthy. In some implementations, the suitable power levels detected at power meter 254 and/or power meter 258 can be accessed from a lookup table or function correlating power amplifier levels within transceiver 280 and expected power levels detected by the power meters. For example, if a component between the two power meters is damaged, power at one end would drop in relation to the other or vice versa. The computing system can then make necessary changes to the operation of terminal 204, such as by activating one or more safety interlock measures. For example, the safety interlock measures can include shutting off the power amplifier in transceiver 206 or closing a receiving aperture if power is not detected at power meter 254. In some implementations, the functions of the computing system can be implemented by controller 260.

Due to the high loss in atmosphere in long distance FSOC links, the transmitting terminal of a link may need to transmit light with high power, such as a few watts or tens of watts, while the receiving terminal may only receive a small portion (e.g., in milli-watt to micro-watt range) of the light transmitted by another terminal. Thus, even if only a small portion of the light to be transmitted is leaked into the receive path (e.g., leaked into the wavefront sensor) or interferes with output from the terminal receiver (e.g., terminal receiver 202), noise in the received light signal may be significantly increased and the signal-to-noise ratio of the received signal may be significantly reduced. In many FSOC systems, to avoid the interference of the light to be transmitted with the received light, a FSOC terminal may include separate transmit path and received path, where the light beam to be transmitted and the received light beam may pass through different optical apertures of the FSOC terminal.

FIG. 3A is an example of a bistatic FSOC system 300. In the illustrated example, a first FSOC terminal 310 may include a transmit subsystem 312 and a receive subsystem 314, where transmit subsystem 312 and receive subsystem 314 may use different optical apertures and different optical antennas and other optics. Similarly, a second FSOC terminal 320 may include a transmit subsystem 322 and a receive subsystem 324, where transmit subsystem 322 and receive subsystem 324 may use different optical apertures and different optical antennas and other optics. When a communication link is established between FSOC terminals 310 and 320, transmit subsystem 312 may transmit light signals to FSOC terminal 320, which may receive the light signals from FSOC terminal 310 using receive subsystem 324. Similar, transmit subsystem 322 may transmit light signals to FSOC terminal 310, which may receive the light signals from FSOC terminal 320 using receive subsystem 314.

Since each bistatic FSOC terminal may need to include separate transmit subsystem and receive subsystem, the bistatic FSOC terminal may include more components (e.g., two sets of optical antennas and other optics). Further, the bistatic FSOC terminal may need additional beam dump and power meter configurations to effectively absorb and measure energy of light passed, scattered, or deflected within terminals 310 and 320. As such, the bistatic FSOC terminal may be complex, bulky, heavy, more expensive, and more difficult to steer. For many FSOC terminals, such as airborne FSOC terminals, it is desirable that the FSOC terminal can be smaller, lighter, cheaper, and easier to steer.

FIG. 3B is an example of a monostatic free-space optical communication system 302. In the illustrated example, a first FSOC terminal 330 may include a transceiver system 332, where light to be transmitted into atmosphere and light received from the atmosphere may pass through a common aperture and a common optical path (e.g., a same optical antenna). Similarly, a second FSOC terminal 340 may include a transceiver system 342, where light to be transmitted into atmosphere and light received from the atmosphere may pass through a common aperture and a common optical path. When a communication link is established between FSOC terminals 330 and 340, transceiver system 332 may transmit light signals to FSOC terminal 340 using a light beam in a first infrared wavelength band, and transceiver system 342 of FSOC terminal 340 may receive the light signals transmitted from FSOC terminal 330. Transceiver system 342 of FSOC terminal 340 may simultaneously transmit light signals to FSOC terminal 330 using a light beam in a second infrared wavelength band, and transceiver system 332 of FSOC terminal 330 may receive the light signals transmitted from FSOC terminal 340.

Since each monostatic FSOC terminal as shown in FIG. 3B may use the same optical antenna and some other common optical components for both transmitting optical signals and receiving optical signals, the terminal may use fewer component, and may be less complex, smaller, lighter, cheaper, and easier to steer. However, it can be very challenging to isolate the light signals to be transmitted from the received light signals to prevent the light signals to be transmitted from contaminating the received light signals.

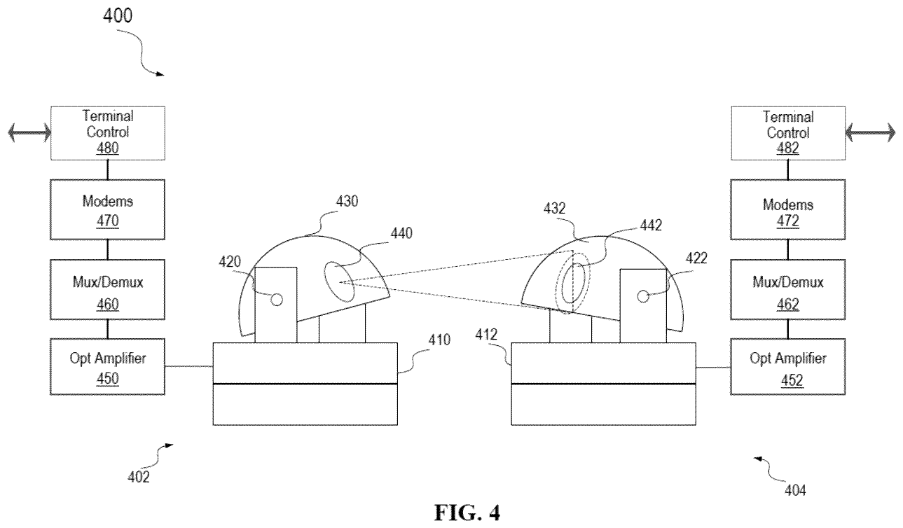

FIG. 4 includes simplified block diagrams of examples of terminals in a free-space optical communication system 400 according to some implementations. A first terminal 402 of FSOC system 400 may include a station 410, which may be fixed or may be steerable (e.g., rotatable). A terminal head 430 of first terminal 402 may be coupled to station 410 through gimbal structure 420, which may pivot, tilt, rotate terminal head 430 and, alone or in combination with station 410, steer terminal head 430 such that a transmit/receive aperture 440 on terminal head 430 of first terminal 402 may face a second terminal 404 for communication with a second terminal 404. Terminal head 430 may include one or more optical antennas for transmitting and/or receiving laser beams, and may also include adaptive optics for aberration correction. For example, first terminal 402 may be a monostatic FSOC terminal as described above with respect to FIG. 3B and described in more detail below. First terminal 402 may include a back end that may include, for example, one or more optical amplifiers 450 (e.g., one or more EDFAs) that may amplify the received light beam or the light beam to be transmitted. A multiplexer/demultiplexer 460 of the back end may multiplex modulated light beams from multiple modulator/demodulators (modems) 470 (and in multiple wavelength bands) into a single light beam to be transmitted, and may demultiplex a received light beam into multiple light beams in different respective wavelength bands, which may then be detected and demodulated by multiple modems 470. The back end of first terminal 402 may also include a terminal control module 480 that may include other circuits, software, and/or firmware, such as network interface cards, network switch, power management circuits, controllers, user interfaces, and the like.

Similarly, second terminal 404 may include a station 412, which may be fixed or may be steerable (e.g., rotatable). A terminal head 432 of second terminal 404 may be coupled to station 410 through a gimbal structure 422, which may rotate terminal head 432 and, alone or in combination with station 412, steer terminal head 432 such that a transmit/receive aperture 442 of second terminal 404 may face first terminal 402 for point-to-point optical communication with first terminal 402. Terminal head 432 may include one or more optical antennas for transmitting and/or receiving laser beams, and may also include adaptive optics for aberration correction. For example, second terminal 404 may be a monostatic FSOC terminal as described above with respect to FIG. 3B and described in more detail below. Second terminal 404 may include a back end that may include, for example, one or more optical amplifiers 452 (e.g., EDFAs) that may be used to amplify the received light beam or the light beam to be transmitted. Second terminal 404 may also include a multiplexer/demultiplexer 462 that may be used to multiplex modulated light beams from multiple modems 472 (and in multiple wavelength bands) into a single light beam to be transmitted, or may demultiplex a received light beam into multiple light beams in different respective wavelength bands, which may be detected and demodulated by multiple modems 472. The back end may also include a terminal control module 482 that may include other circuits, software, and/or firmware, such as a network interface card, a network switch, power management circuits, one or more controllers, a user interface, and the like.

To start a communication link between first terminal 402 and second terminal 404, first terminal 402 may receive information (e.g., location information) of second terminal 404, and may steer terminal head 430 to point to second terminal 404 and transmit a laser beam (e.g., a beacon beam) towards second terminal 404. Additionally or alternatively, second terminal 404 may receive information (e.g., location information) of first terminal 402, and may steer terminal head 432 to point to first terminal 402 and transmit a laser beam towards first terminal 402. First terminal 402 may steer terminal head 430 to try to acquire the laser beam transmitted by second terminal 404 to establish a link between first terminal 402 and second terminal 404. Additionally or alternatively, second terminal 404 may steer terminal head 432 to try to acquire the laser beam transmitted by first terminal 402 to establish a link between first terminal 402 and second terminal 404. Data transmission may begin after the link is established.

During the data transmission, light beams received by the optical antenna of a terminal may be corrected by adaptive optics of the terminal and coupled into a terminal receiver for light detection and signal demodulation as described with respect to, for example, FIG. 2. In many AO systems, the performance of phase-only AO compensation may be limited due to, for example, limited accuracy and/or resolution of the phase aberration estimation or measurement, and/or limited phase compensation range, resolution, accuracy, and speed of the phase compensation components (e.g., deformable mirrors or SLMs). For example, real-time adaptive optics may need to use phase wavefront measurement results, which may be difficult to measure in some communication scenarios. According to certain embodiments, to improve the performance of the adaptive optics system of an FSOC terminal, aberrations in different spatial and/or temporal frequency bands may be corrected using different techniques.

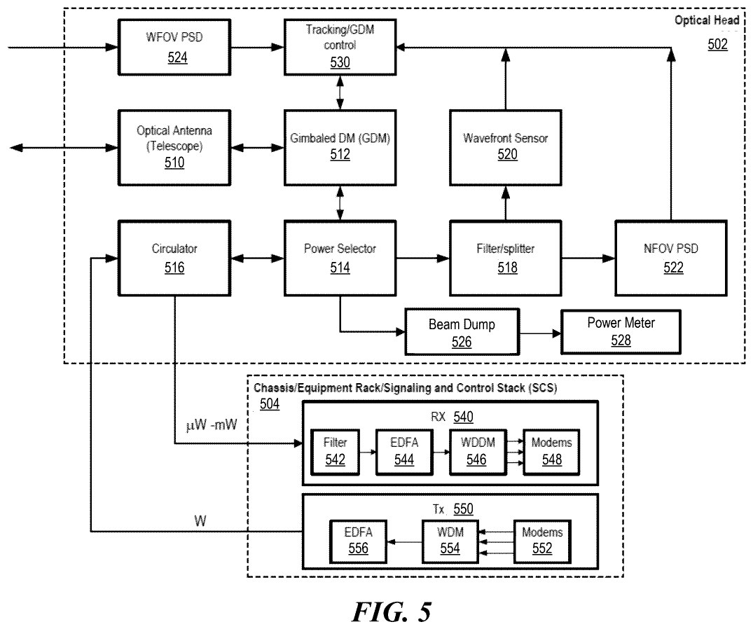

FIG. 5 illustrates a block diagram of an example of a free-space optical communication terminal 500 according to some implementations. In the illustrated example, FSOC terminal 500 may be a monostatic FSOC terminal, and may include an optical head 502 and a chassis 504 (also referred to herein as equipment rack or signaling and control stack (SCS)). It is noted that FIG. 5 is for illustrative purposes only. In various embodiments, some system blocks shown in FIG. 5 may be optional, some other system blocks may be added to FSOC terminal 500, and/or the system blocks of FSOC terminal 500 may be partitioned in different manners. In the illustrated example, optical head 502 may include an optical antenna 510, a gimbaled deformable mirror (GDM) 512, a power selector 514, a circulator 516, a beam splitter 518, a wavefront sensor 520, and a tracking/GDM controller 530. Optical antenna 510 may include one or more telescopes, and may be used to demagnify a received light beam and magnify a light beam to be transmitted. GDM 512 may be used to correct the angle of incidence of the received light beam from optical antenna 510 or the light beam to be transmitted. Power selector 514 may be used to direct a portion of the received light beam to circulator 516, and direct a portion of the received light beam to beam splitter 518. Power selector 514 may also be used to direct a portion of the light beam to be transmitted from circulator 516 to GDM 512. In some implementations, power selector 514 can direct a portion of the light beam to be transmitted to a beam dump 526, which can reflect a small amount of the light beam (e.g., 1-5%) to power meter 528 for measuring the power of the light beam to be transmitted, and can trap and absorb the remainder of the light beam. In other words, beam dump 526 can absorb excess energy to a high degree without generating scattered or back reflected light into FSOC terminal 500, which could otherwise disrupt operation of FSOC terminal 500, e.g., such as by damaging wavefront sensor 520 or other sensitive components.

Circulator 516 may include at least three ports, where light input from the first port may be output at a second port and light input from a third portion may be output at the first port. Circulator 516 may be used to direct the received light beam from power selector 514 (e.g., optically coupled to the first port of circulator 516 through a collimator and an optical fiber) to a receive subsystem 540 (e.g., optically coupled to the second port of circulator 516 through an optical fiber) of chassis 504 for light signal detection and demodulation. Circulator 516 may also be used to direct the light beam to be transmitted from a transmit subsystem 550 (e.g., optically coupled to the third port of circulator 516 through an optical fiber) of chassis 504 to power selector 514 so that a portion of the light beam to be transmitted may be directed to GDM 512 and optical antenna 510 for transmitting. A collimator (not shown in FIG. 5) or another coupler may be used to focus and couple the received light beam into an optical fiber (not shown in FIG. 5) that may be coupled to a port of circulator 516, and may also be used to collimate a light beam to be transmitted from circulator 516 through the optical fiber. Beam splitter 518 may be used to split a portion of the received light beam from power selector 514 into two beams and direct the two beams toward wavefront sensor 520 and a narrow field of view (NFOV) position sensitive detector (PSD) 522, respectively. Wavefront sensor 520 may include, for example, a Shack-Hartmann wavefront sensor, and may be used to measure the wavefront profile of the received light beam. The measured wavefront profile of the received light beam may be used by tracking/GDM controller 530 to control GDM 512 to correct the wavefront of the received light beam.

In order for two terminals to establish a point-to-point link for data communication, a terminal may need to shine a high-power and broad beacon beam for the other terminal to find, before using narrower beams for high data rate communication. Therefore, in addition to transmitting and receiving light beams for data communication, optical head 502 may include components for acquiring and tracking a beacon beam and controlling actuators to steer optical head 502 until the beacon beam forms an image at the center of a position sensitive detector. Optical head 502 may also include components for transmitting and/or scanning a beacon beam for another terminal to locate FSOC terminal 500. In the example shown in FIG. 5, optical head 502 may include a wide field of view (WFOV) PSD 524 that may have a wider field of view but may have a lower resolution. WFOV PSD 524 may acquire the beacon beam through a separate window. The measurement results of WFOV PSD 524 may be used for coarse beacon beam tracking. NFOV PSD 522 may have a smaller field of view but may have a higher resolution, and the measurement results of NFOV PSD 522 may be used for more accurate beacon beam tracking. In some implementations, GDM 512 may be controlled by tracking/GDM controller 530 for beacon beam acquisition and tracking. For example, GDM 512 may be controlled by tracking/GDM controller 530 to scan a beacon beam to be transmitted within a certain field of regard, such that the transmitted beacon beam may be found by another terminal. GDM 512 may also be controlled to change the wavefront of a beacon beam to be transmitted, so that the beacon beam may be diverged to have a large divergence angle and thus could be acquired by a terminal within a large region. GDM 512 may also be controlled to change the direction of a received beacon beam so that the received beacon beam may be imaged onto a center of NFOV PSD 522.

Chassis 504 may process the received light beam to decode the transmitted data and may generate data modulated light beam for transmitting to another terminal. In chassis 504, the receive path and the transmit path may be separate or may partially overlap. Receive subsystem 540 of chassis 504 may include an optical filter 542, one or more EDFAs 544, a wavelength-division demultiplexer (WDDM) 546, and one or more modems 548. Optical filter 542 may filter out any stray light that is not in the passband of optical filter 542, such as light from the light beam to be transmitted by FSOC terminal 500 or ambient light. The one or more EDFAs 544 may amplify the received light beam that may have a low power. WDDM 546 (e.g., including a grating or a waveguide device) may split the received light beam into multiple beams having light within different respective narrow wavelength ranges. In some implementations, multiple add/drop modules may be used to split the received light beam into multiple beams having light within different respective narrow wavelength ranges, where each add/drop module may “drop” light in a respective narrow wavelength range so that the dropped light may be demodulated by a modem 548 to decode the transmitted data. Each modem 548 may include an optical demodulator and a high-speed photodetector, or may include a high-speed photodetector and an electrical demodulator.

Transmit subsystem 550 of chassis 504 may include one or more modems 552 (e.g., including optical modulators), a wavelength division multiplexer (WDM) 554 (or multiple optical add/drop modules), and one or more EDFAs 556. Modems 552 may be used to modulate laser beams of different respective wavelengths using data to be transmitted. The modulated laser beams may be multiplexed into a single laser beam using WDM 554 or multiple add/drop modules. The output laser beam of WDM 554 may be amplified by one or more EDFAs 556 to boost the power of the light beam to, for example, several watts or several tens of watts. The amplified laser beam may be directed, through circulator 516, to power selector 514, GDM 512, and optical antenna 510 for transmission.

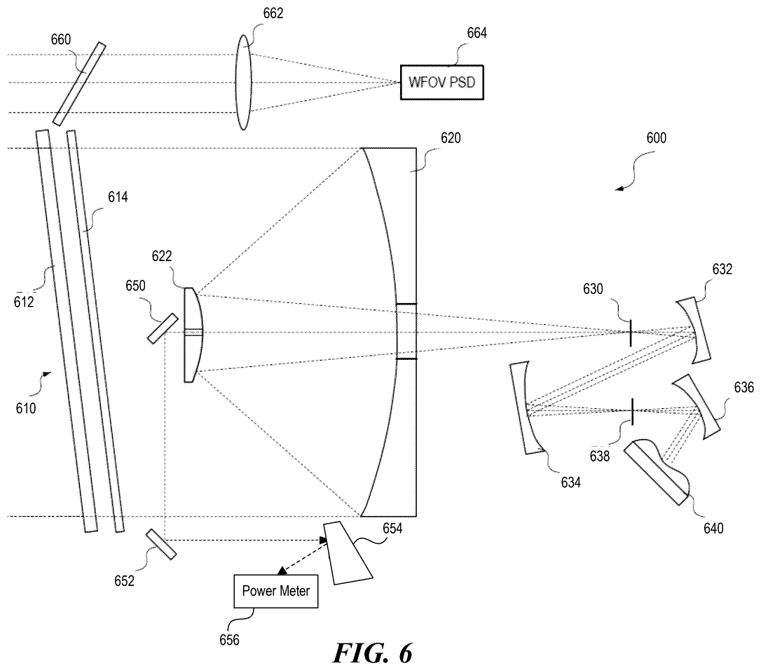

FIG. 6 illustrates an example of an optical front end in an optical head 600 of a free-space optical communication terminal according to some implementations. Optical head 600 may be an example of optical head 502 of FIG. 5. In the illustrated example, optical head 600 may include a system window 610 and an optical antenna that may include two telescopes made of reflective mirrors. Optical head 600 may receive laser beams from atmosphere through system window 610, and may also transmit laser beams into atmosphere through system window 610. The optical antenna may be used to demagnify a received laser beam so that the received laser beam may be coupled into an optical fiber and sent to a modem. The optical antenna may also be used to magnify a laser beam to be transmitted so that the transmitted laser beam may have a low divergence angle.

System window 610 may include, for example, an outer layer 612 and an inner layer 614. Outer layer 612 of system window 610 may allow infrared to pass through and may be used to seal and protect other components inside optical head 600. Outer layer 612 may also be water-resistive and heat resistive. In one example, outer layer 612 may include a silicon substrate with a coating, such as an antireflective coating, a hydrophobic coating, an abrasion-resistant coating, or a combination thereof. Inner layer 614 may be used to, for example, block solar light or other background light that may interfere with the light for data communication. Inner layer 614 may include, for example, a transparent substrate with a solar-blocking coating, one or more bandpass filters, an antireflective coating, or a combination thereof. In some embodiments, outer layer 612 and/or inner layer 614 may include a heater for heating system windows and removing water, ice, frost, and the like.

In the example shown in FIG. 6, the optical antenna may include a first telescope and a second telescope. The first telescope may be a Cassegrain telescope (or a modified Cassegrain telescope or another type of telescope) that includes a primary mirror 620 and a secondary mirror 622. Primary mirror 620 may be a concave mirror with a large aperture (the system aperture), and may focus a received laser beam and direct the laser beam towards secondary mirror 622, which may be a concave mirror or a convex mirror. Secondary mirror 622 may direct the focused laser beam to a center region of primary mirror 620 that may be a transmission region and may allow the focused laser beam to pass though. In some embodiments, a center region of secondary mirror 622 may be a transmission region and may allow a portion of the focused laser beam from primary mirror 620 to pass through and be directed by mirrors 650 and 652 to a beam dump 654. Beam dump can reflect a small portion (e.g., 1-5%) of the received laser beam to power meter 656 and trap and absorb the remainder of the received laser beam through total internal reflection. Power meter 656 may measure the power of the small portion of the laser beam reflected by beam dump 654, and the outputs of power meter 656 may be used to, for example, estimate the total power of the received laser beam. In some embodiments, the center region of secondary mirror 622 may be used to transmit a beacon beam that may have a large divergence angle. For example, the beacon beam may pass through the center region of primary mirror 620 and the center region of secondary mirror 622 into the atmosphere.

A field stop 630 may be positioned at or near a focal point of the Cassegrain telescope to spatially filter the received laser beam, such as removing some speckles at the peripheral regions of the received laser beam. In some embodiments, field stop 630 may be an active aperture, the size of which may be adjusted based on, for example, the operation mode of optical head 600, the power of the received laser beam, and the like. The filtered laser beam may be further demagnified by the second telescope, which may relay the system aperture to the optical back end of optical head 600. In the illustrated example, the second telescope may include a mirror 632, a mirror 634, and a mirror 636. Mirror 632 and mirror 634 may focus the received laser beam, and a field stop 638 may be positioned at a focal point. Field stop 638 may also be an active aperture. Mirror 636 may collimate the received laser beam to form a substantially collimated laser beam with a small beam size, and direct the collimated laser beam towards a deformable mirror 640. The second telescope may relay the system aperture (e.g., primary mirror 620) to deformable mirror 640 by forming an image of primary mirror 620 on deformable mirror 640. Deformable mirror 640 may tune the wavefront of the laser beam to correct aberrations as described in detail above and below. Using telescopes formed by reflective optical devices may fold the light path, thereby reducing the physical dimensions of the optical antenna.

In some embodiments, optical head 600 may also include a wide field of view (WFOV) beam position sensing system for laser beam (e.g., beacon beam) acquisition and tracking. The WFOV beam position sensing system may receive a portion of a laser beam through system window 610 or a separate window 660, and may form an image of the received laser beam on a WFOV PSD 664 using a lens assembly 662. Based on the position of the image of the received laser beam on WFOV PSD 664, the direction of the laser beam (beacon beam) and the line of sight direction of the terminal that transmits the laser beam may be estimated, and optical head 600 may be oriented accordingly to position the image of the received laser beam at the center of WFOV PSD 664.

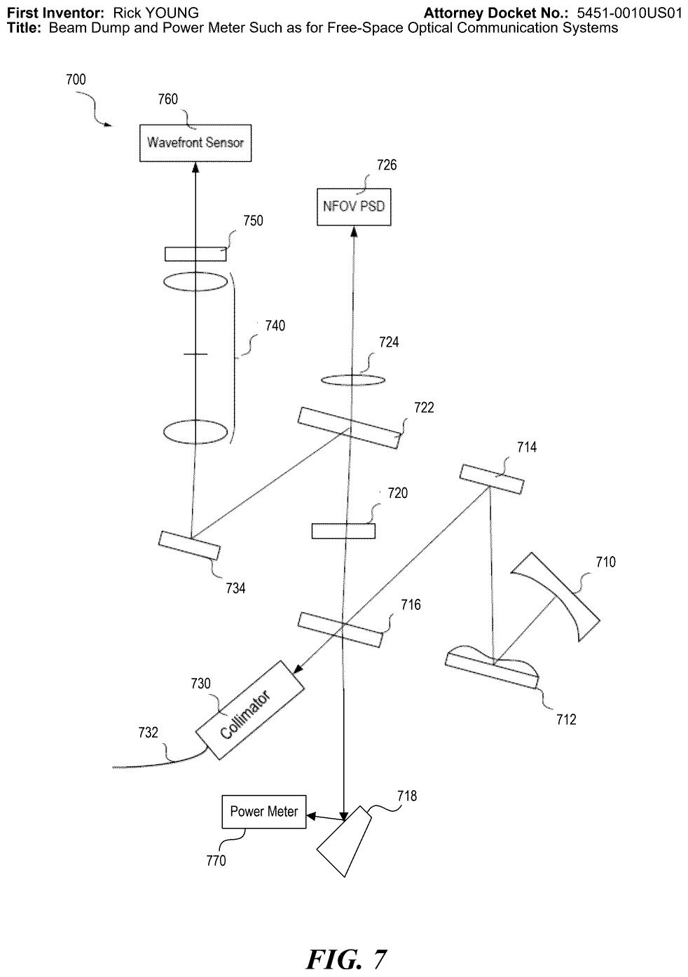

FIG. 7 illustrates an example of an optical back end 700 in an optical head of a free-space optical communication terminal according to some implementations. Optical back end 700 shown in FIG. 7 may be an example of the optical back end of optical head 502 of FIG. 5. In the illustrated example, optical back end 700 may include a GDM 712 that may receive a laser beam from a mirror 710 (e.g., mirror 636 shown in FIG. 6) in the receive path. GDM 712 may also reflect a laser beam to be transmitted to mirror 710 in the transmit path. As described in detail below, GDM 712 may be pivoted or tilted as a whole by micro-gimbals, and the reflective surface of GDM 712 may also be tuned by individual micro-activators that may each change the shape and/or position of a small region of the reflective surface. GDM 712 may be configurable to, for example, correct aberrations of the received laser beam, scan a beacon beam to be transmitted into atmosphere for laser beam tracking, scan within a field of regard to acquire a beacon beam transmitted through atmosphere, diverge a beacon beam to be transmitted to atmosphere, or a combination thereof.

As illustrated, GDM 712 may direct the received laser beam to a fold mirror 714, which may fold the laser beam and direct the laser beam towards a power selector 716. In some embodiments, GDM 712 may reflect the received laser beam towards a power selector 716 directly, and thus fold mirror 714 may not be used. Power selector 716 may direct (e.g., reflect or deflect) a portion (e.g., 1%, 2%, 5%, or 10%) of the laser beam to a filter 720, which may allow light in a first infrared band (e.g., light in the received laser beam) to pass through and may block (e.g., absorb) light outside the first infrared band (e.g., stray light from the laser beam to be transmitted to another terminal). Power selector 716 may allow another portion of the laser beam from fold mirror 714 to pass through and be coupled into an optical fiber 732 by a collimator 730 (e.g., a lens, such as a GRIN lens), where optical fiber 732 may send the received laser beam to a receiver subsystem for processing as described above with respect to, for example, FIGS. 4 and 5 and described in detail below. In the transmit path, a laser beam to be transmitted may be guided by optical fiber 732, collimated by collimator 730, and split by power selector 716. A fraction (e.g., 1%, 2%, 5%, or 10%) of the laser beam to be transmitted may be sent (e.g., reflected or deflected) by power selector 716 to beam dump 718. Beam dump 718 can reflect a fraction of the laser beam received from power selector 716 (e.g., 1%, 2%, 5%, or 10%) to power meter 770 to estimate the power of the laser beam to be transmitted. Beam dump 718 can trap and absorb the remainder of the laser beam received from power selector 716 through total internal reflection. The remaining portion of the laser beam to be transmitted may be sent (e.g., transmitted) by power selector 716 to fold mirror 714 and/or GDM 712 for transmission by the optical antenna.

In the receive path, the portion of the received laser beam may be filtered by filter 720 to block stray light or other noise signals, and may then be split by a beam splitter 722 (e.g., a wedged beam splitter) into a first portion and a second portion. The first portion may be directed toward a lens 724 (or lens assembly) and a narrow field of view (NFOV) PSD 726. Lens 724 may form an image of the laser beam on a region of NFOV PSD 726. The location of the image of the laser beam on NFOV PSD 726 may indicate the angle or direction of the received laser beam. NFOV PSD 726 may have a higher resolution than, for example, WFOV PSD 664. Therefore, NFOV PSD 726 may be used for more accurate laser beam acquisition and tracking. The second portion of the laser beam split by beam splitter 722 may be folded by a fold mirror 734 and may be relayed by a pupil relay telescope 740 to a pupil plane (forming an image of, e.g., primary mirror 620) on wavefront sensor 760. A filter 750 similar to filter 720 may be used to further filter the laser beam to be measured by wavefront sensor 760. Wavefront sensor 760 may be used to measure the wavefront profile of the received laser beam to determine the aberrations caused by, for example, atmospheric turbulence. In one implementation, wavefront sensor 760 may include a Shack-Hartmann wavefront sensor.

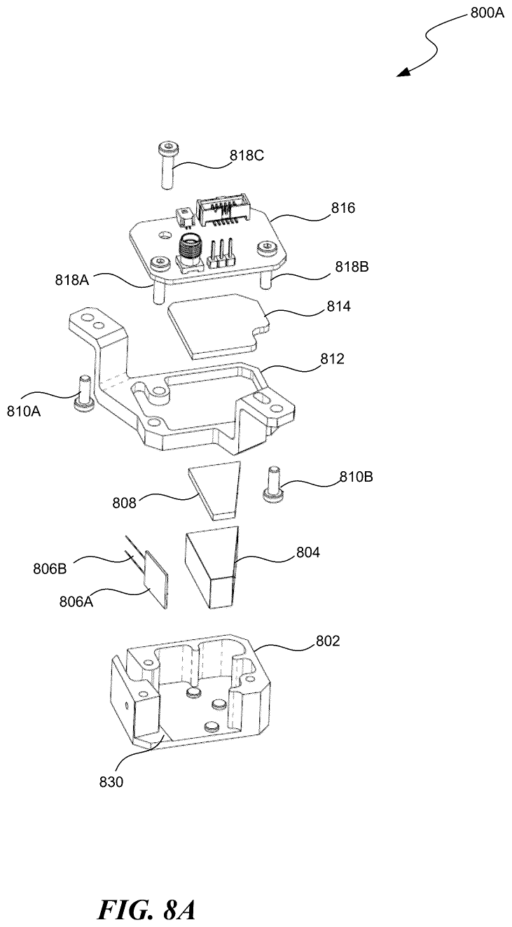

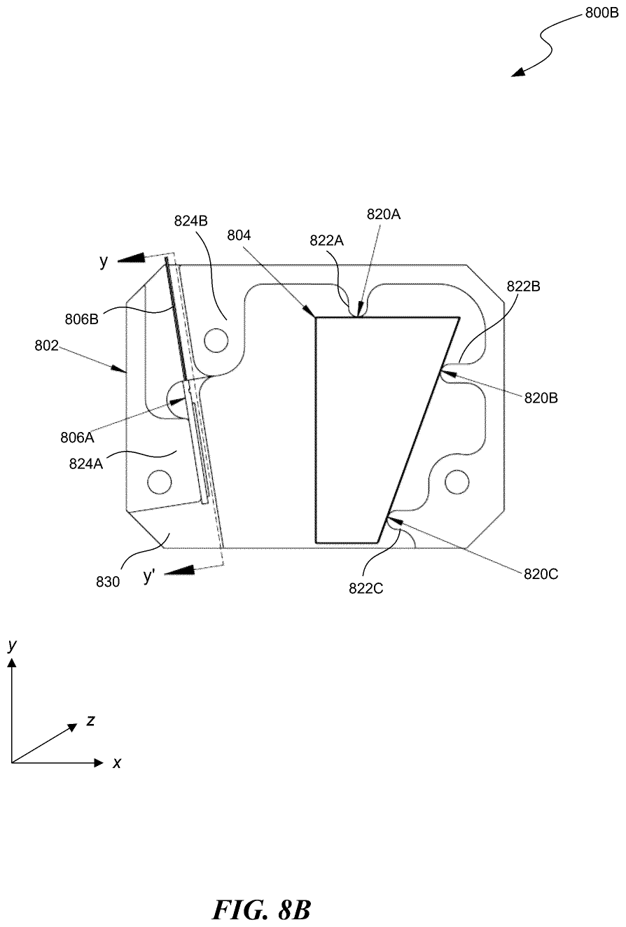

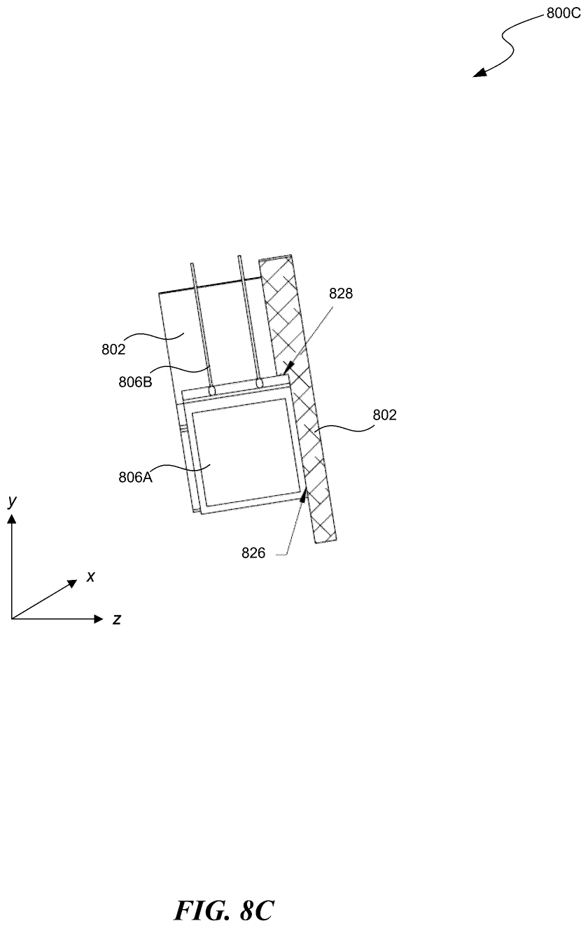

FIG. 8A illustrates an example exploded perspective view of a beam dump assembly 800A for an optical front end or an optical back end in an optical head of a free-space optical communication (FSOC) terminal according to some implementations. Beam dump assembly can include mount 802 for prism 804 and photo diode 806A with connectors 806B. Prism 804 can be similar in structure and/or functionality to any of the prisms described herein, while photo diode 806A can be an exemplary power meter as described herein. Prism 804 and photo diode 806A can be fitted into mount 802, as shown in the top view of FIG. 8B. FIG. 8B illustrates a top view of a partial beam dump assembly 800B having a mounted prism 804 and photo diode 806A for an optical head of an FSOC terminal according to some implementations. Mount 802 can be sized and configured to mount prism 804, with the internal flat surfaces of mount 802 having a black light absorbing coating. For example, as shown in FIG. 8B, mount 802 can include protrusions 822A-822C that are configured, sized, and positioned to secure prism 804 at three points 820A-820C. Although illustrated as contacting prism 804 at three points 820A-820C, however, it is contemplated that mount 802 can include any number of protrusions contacting prism 804 at any number of points, while securing prism 804 within its bounds.

Mount 802 can further be sized and configured to mount photo diode 806A. For example, as shown in FIG. 8B, mount 802 can hold photo diode 806A and connectors 806B between protrusion 824A and protrusion 824B on opposite ends. Protrusions 824A-824B can be configured, sized, and positioned to secure photo diode 806A and connectors 806B. In some implementations, photo diode 806A can be held at such an angle so as to direct reflections off its surface away from the incoming light path, further minimizing the scatter and/or reflectance of the assembly. FIG. 8C is a cross-sectional view at y-y′ (illustrated in FIG. 8B) of a partial beam dump assembly 800C having a mounted photo diode 806A with connectors 806B for an optical head of an FSOC terminal according to some implementations. As shown in FIG. 8C, mount 802 can abut photo diode 806A along the y-axis, as shown, e.g., at point 826. Mount 802 can further include notch 828 for holding and securing photo diode 806A within mount 802.

Turning back to FIG. 8A, prism 804 can abut beam dump thermal pad 808 which is shaped, sized, and configured as a trapezoid to cover a trapezoidal face of prism 804. Thermal pad 808 can abut a further thermal pad 814 which is shaped, sized, and configured to cover the trapezoidal face of thermal pad 808, while fitting within power dump spacer 812. In some implementations, power dump spacer 812 can space thermal pad 814 from thermal pad 808 with air. Thermal pads 808 and 814 can be configured to dissipate heat generated by prism 804 in performing absorption and total internal reflection as described further herein. Thermal pads 808 and 814 can be composed of any suitable material or combination of materials having high thermal conductivity, and, in some implementations, can be composed of different materials. Exemplary materials having high thermal conductivity includes, for example, silicone, germanium, gallium arsenide, glass, etc. In some implementations, thermal pad 814 can include a thermistor that alerts the FSOC terminal if beam dump assembly 800A becomes too hot. Printed circuit board assembly 816 can be secured via screws 818A-818C through power dump spacer 812 to mount 802 to secure the various components within beam dump assembly 800A. Printed circuit board assembly 816 can process signals from photo diode 806A, and thermistor, and/or other sensors and/or electronics. In some implementations, printed circuit board assembly 816 can include a thermistor itself or other temperature-sensing device. Power dump spacer 812 can further be secured to the FSOC terminal, via screws 810A-810B, in a position to intercept the laser beam that needs to be dumped and/or measured. In some implementations, mount 802, power dump spacer 812, and printed circuit board assembly 816 can form a housing for prism 804 and photo diode 806A.

Beam dump assembly 800A can be positioned within the FSOC terminal such that a portion of a laser beam travels through air and enters beam dump assembly 800A at opening 830, illustrated in FIGS. 8A and 8B, striking prism 804. In some implementations, prism 804 can absorb the energy of the received portion of the laser beam, as described further herein. In some implementations, however, prism 804 can include an exterior coating on its receiving face, facing opening 830, which can reflect a small portion of the received laser beam onto photo diode 806A. Photo diode 806A is an exemplary component that can act as a power meter described herein, measuring power of the reflected laser beam. Photo diode 806A can then communicate the measured power to an external component, such as a controller or computing system, which can monitor the measured power at beam dump assembly 800A (and potentially another beam dump assembly in the FSOC terminal or other FSOC terminals), and make any appropriate operational changes as described herein.

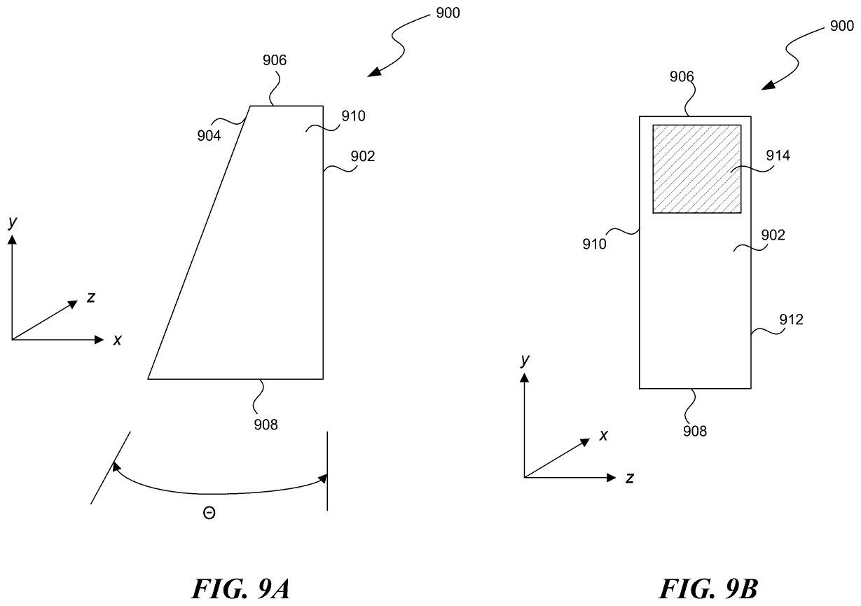

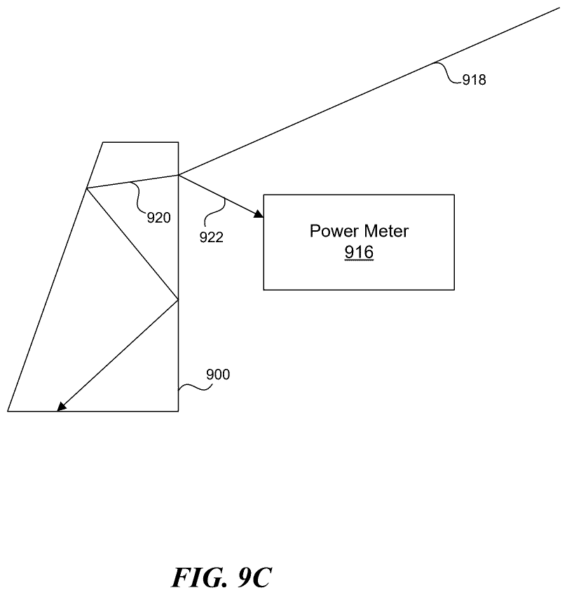

FIG. 9A illustrates an example top view of a prism 900 for a beam dump assembly according to some implementations. FIG. 9B illustrates an example side view of prism 900 according to some implementations. FIG. 9C illustrates an example view of a laser beam traveling through a beam dump assembly including a prism 900 and a power meter 916 for measuring power of a portion of the laser beam.

Prism 900 can have first face 902, second face 904, third face 906, fourth face 908, fifth face 910, and sixth face 912, which can each be planar. First face 902 can have a first end in a y-direction perpendicularly adjoining third face 906, and a second end in the y-direction perpendicularly adjoining fourth face 908. Second face 904 can oppose first face 902 in the x-direction and can adjoin third face 906 at a first end in the y-direction opposite to the first end of first face 902 in the x-direction, and adjoin fourth face 908 at a second end in the y-direction opposite to the second end of first face 902 in the x-direction. Second face 904 can be positioned at an angle Θ relative to first face 902 in the y-direction. In some implementations, the angle Θ can be about 20 degrees relative to first face 902, e.g., within a range of 19.5 to 20.5 degrees. In some implementations, the ratio of the length of first face 902 in the z-direction to its length in the y-direction is about 1:2.4, e.g., 1:2.36 to 1:2.44.

Third face 906 can extend in the x-direction between first face 902 and second face 904 at their respective first ends in the y-direction, and extend in the z-direction between fifth face 910 and sixth face 912 at their respective first ends in the y-direction. Fourth face 908 can oppose third face 906 in the y-direction. Fourth face 908 can extend in the x-direction between first face 902 and second face 904 at their respective second ends in the y-direction, and extend in the z-direction between fifth face 910 and sixth face 912 at their respective second ends in the y-direction. In some implementations, third face 906 and fourth face 908 can be parallel. In some implementations, the ratio of the lengths of third face 906 to fourth face 908 in the x-direction can be about 1:2.32, e.g., between 1:2.29 to 1:2.36. In some implementations, the ratio of the length of third face 906 in the x-direction to the length of first face 902 in the y-direction can be about 1:3.62, e.g., between 1:3.57 to 1:3.67.

Fifth face 910 can have a first end in the y-direction adjoining to third face 906, and a second end in the y-direction adjoining to the fourth face 908. Similarly, sixth face 912 can have a first end in the y-direction adjoining to third face 906, and a second end in the y-direction adjoining to the fourth face 908. Fifth face 910 can extend between first face 902 and second face 904 in the x-direction, and third face 906 and fourth face 908 in the y-direction. Similarly, sixth face 912 can extend between first face 902 and second face 904 in the x-direction, and third face 906 and fourth face 908 in the y-direction. In some implementations, fifth face 910 and sixth face 912 can be parallel. In some implementations, fifth face 910 and sixth face 912 can be right trapezoids.

Prism 900 can be composed of any semiconductor material, including, for example, silicon, germanium, gallium arsenide, and/or any compounds including one or more of such semiconductor materials. In some implementations, the semiconductor can be doped, such as with any n- or p-type dopant. In some implementations, the semiconductor can be doped with boron or a combination of boron with one or more other dopants. In some implementations, the semiconductor can be doped with gallium, indium, phosphorus, arsenic, antimony, or any combination thereof. In some implementations, the doped semiconductor can have high thermal conductivity, e.g., thermal conductivity above 10. In some implementations, the density of the dopant can be between 1×10¹⁶ per cubic centimeter to 1×10²⁰ per cubic centimeter. In some implementations, the density of the dopant can be 1×10¹⁸ per cubic centimeter, or about 1×10¹⁸ per cubic centimeter, e.g., within a +/−25% margin of 1×10¹⁸ per cubic centimeter, giving prism 900 a suitable amount of absorption per volume to perform the functions described herein. In some implementations, the doping of the semiconductor can shift its absorption region into the targeted wavelength range of portion 922 of laser beam 918, e.g., a wavelength range between 1540-1570 nm.

In some implementations, first face 902 can include a coating 914 at its first end in the y-direction, as shown in FIG. 9B. In some implementations, coating 914 can be an antireflection coating. In some implementations, coating 914 can be formed on first face 902 by laminating or depositing one or more layers of dielectric material onto first face 902. In some implementations, coating 914 can be substantially square, e.g., with each side having a length within a 2.5% margin of each other. In some implementations, coating 914 can be bordered on one or more of its sides by an area of prism 900 not having coating 914. In some implementations, the length of the uncoated area between coating 914 and the first end of first face 902 in the y-direction can be between 5-6% of the length of coating 914 in the y-direction. In some implementations, the length of the uncoated areas in the x-direction between coating 914 and the sides of first face 902 can be between 5-6% of the length of coating 914 in the y-direction. In some implementations, the length of the uncoated area between coating 914 and the first end of first face 902 in the y-direction and the lengths of the uncoated areas in the x-direction between coating 914 and the sides of first face 902 can be substantially the same, e.g., within +/−5% of each other. In some implementations, however, coating 914 can be omitted from first face 902.

As shown in FIG. 9C, in some implementations, coating 914 can be configured to receive laser beam 918 at the first end (in the y-direction) of first face 902. Laser beam 918 can be a laser beam to be transmitted by a free-space optical communication terminal as described herein, or a laser beam received at a free-space optical communication terminal as described herein. Coating 914 can be configured to reflect a portion 922 of laser beam 918 (e.g., 1%, 2%, 5%, or 10%) to power meter 916. In some implementations, coating 914 can be configured to reflect about 1% of laser beam 918, e.g., between 0.9-1.1% of the laser beam, to power meter 916. In some implementations, coating 914 can reflect about 1% of laser beam 918 at about a 1555 nm wavelength, e.g., a wavelength range between 1540-1570 nm with a +/−0.25% tolerance over range. Power meter 916 can be configured to measure the power of the laser beam 918 to be transmitted, or received laser beam 918. Prism 900 can trap the remaining portion 920 of the laser beam (i.e., the portion of the laser beam not reflected to power meter 916). Portion 920 of the laser beam can internally reflect off first face 902, second face 904, third face 906, fourth face 908, fifth face 910, sixth face 912, or any combination thereof, within prism 900, with total internal reflection. In some implementations, prism 900 can be configured such that portion 920 of the laser beam cannot reflect back to coating 914 where laser beam 918 was received.

In some implementations, one or more portions of first face 902 can include a coating alternative or additional to coating 914, such as a coating surrounding coating 914 (not shown). In some implementations, prism 900 can be fully coated on first face 902 with coating 914 and/or the additional coating. In some implementations, the additional coating can be a light absorbing black coating with low reflectance. In some implementations, the additional coating can be an antireflection coating. Thus, if some of portion 922 of the laser beam reflects off of power meter 916 back toward first face 902 of prism 900, its coating will absorb the scattered light and not reflect it back into the free-space optical communication system terminal.

Although described primarily herein in relation to prism 900, it is contemplated that the beam dump assembly can alternatively employ different configurations to trap light beams. For example, in some implementations, the beam dump assembly can include an integrating sphere. In another example, the beam dump assembly can include a stack of neutral density filters in a spaced fashion. In still another example, the beam dump assembly can include one or more components composed of glass, such as a glass prism. Further, although described primarily herein as being used within FSOC systems, it is contemplated that the beam dump and/or power meter described herein can be implemented in any collimated light system needing absorption of excess light and/or one or more power reading of light within the system.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A beam dump system for absorbing power of a laser beam, the beam dump comprising:
a prism configured to absorb power of a first portion of the laser beam, the prism including:
a first face configured to receive the first portion of the laser beam at a first end, the first face having the first end and a second end,
wherein the first end includes a coating, the coating being configured to pass the first portion of the laser beam into the prism and reflect a second portion of the laser beam;
a second face opposite to the first face and positioned at an angle relative to the first face, the second face having a first end and a second end;
a third face extending perpendicularly to the first face and extending between the first end of the first face and the first end of the second face; and
a fourth face opposite the third face and extending perpendicularly to the first face and extending between the second end of the first face and the second end of the second face, wherein the prism comprises at least one semiconductor, doped with at least one dopant;
wherein the prism is configured to trap the first portion of the laser beam within the prism by total internal reflection, and
wherein the at least one semiconductor, doped with the at least one dopant, absorbs the first portion of the laser beam.

2. The beam dump system of claim 1, wherein the prism further includes:
a fifth face extending perpendicularly to the first face and connecting to each of the first face, the second face, the third face, and the fourth face; and
a sixth face opposite the fifth face extending perpendicularly to the first face and connecting to each of the first face, the second face, the third face, and the fourth face,
wherein the fifth face and the sixth face are trapezoids.

3. The beam dump system of claim 1, wherein the at least one dopant includes a p-dopant.

4. The beam dump system of claim 3, wherein the p-dopant is boron.

5. The beam dump system of claim 1, wherein a density of the at least one dopant in the at least one semiconductor is approximately 10¹⁸ cm⁻³.

6. The beam dump system of claim 1, wherein the at least one semiconductor includes silicon.

7. The beam dump system of claim 1, wherein the at least one semiconductor has high thermal conductivity.

8. The beam dump system of claim 1, wherein the angle is approximately 20 degrees.

9. The beam dump system of claim 1, wherein the coating is configured to reflect the second portion of the laser beam at a wavelength range of about 1540 nm to about 1570 nm.

10. The beam dump system of claim 1, wherein the coating is an antireflection coating.

11. The beam dump system of claim 1, wherein the second portion is approximately 1% of the power of the laser beam.

12. The beam dump system of claim 1, wherein the prism is configured to trap the first portion of the laser beam by reflecting, with by total internal reflection, the first portion of the laser beam off multiple faces, the multiple faces including at least two of the first face, the second face, and the third face.

13. The beam dump system of claim 1, further comprising:
a power meter;
wherein the coating is configured to reflect the second portion of the laser beam to the power meter; and
wherein the power meter configured to receive the second portion of the laser beam and measure power of the second portion of the laser beam.

14. An optical system comprising:
an optical antenna configured to receive and/or transmit one or more laser beams;
a deformable mirror configured to:
scan, within a field of regard, a beacon beam to be transmitted for laser beam tracking, or
acquire a beacon beam transmitted by a first terminal by scanning within the field of regard;
a power selector configured to split a first laser beam, of the one or more laser beams, into a first light beam and a second light beam;
a wavefront sensor configured to measure a wavefront of the first laser beam;
a beam dump comprising a doped semiconductor prism, the beam dump configured to:
trap, by total internal reflection, at least a portion of the first laser beam, such that at least the portion is not reflected onto the wavefront sensor, and
absorb, via the doped semiconductor prism, at least the portion of the beacon beam;
a collimator configured to couple the second light beam into an optical fiber; and
a controller configured to control the deformable mirror based on the measured wavefront.

15. The optical system of claim 14,
wherein the at least the portion is a first portion of the beacon beam, and
wherein the optical system further comprises:
a power meter configured to detect power of a second portion of the first laser beam reflected by the beam dump.

16. The optical system of claim 15, wherein the beam dump includes an area covered with an antireflection coating configured to pass at least the portion of the first laser beam into the doped semiconductor prism and reflect the second portion of the beacon beam to the power meter.

17. The optical system of claim 14, wherein the doped semiconductor prism comprises silicon doped with boron.

18. A beam dump assembly comprising:
a housing having an opening configured to receive a laser beam having a wavelength;
a trapezoidal prism comprising a semiconductor and a dopant, the trapezoidal prism being positioned within the housing and configured to:
receive and trap at least a portion of the laser beam via total internal reflection, and
absorb at least the portion of the laser beam; and
one or more thermal pads between the trapezoidal prism and the housing configured to dissipate heat generated by the trapezoidal prism,
wherein a type of the dopant and an amount of the dopant within the semiconductor are selected to absorb the portion of the laser beam at the wavelength before the portion of the laser beam reflects internally in the trapezoidal prism above a threshold amount.

19. The beam dump assembly of claim 18,
wherein the at least the portion of the laser beam is a first portion of the laser beam,
wherein the trapezoidal prism is configured to reflect a second portion of the laser beam, and
wherein the beam dump assembly further comprises:
a power meter positioned within the housing and opposite the trapezoidal prism, wherein the power meter is configured to receive and measure power of the second portion of the laser beam.

20. The beam dump assembly of claim 19, wherein the power meter includes a photo diode.
